(19) United States
(12) Patent Application Publication
(10) Pub. No.: US 2016/0208524 A1
(43) Pub. Date: Jul. 21, 2016

(54) MOTOR VEHICLE LOCK WITH A POSITION SECURING SYSTEM

(71) Applicant: KIEKERT AKTIENGESELLSCHAFT, Heiligenhaus (DE)

(72) Inventors: Bernado ERICES, Bergisch-Gladbach (DE); Madhu S. BASAVARAJAPPA, Düsseldorf (DE); Nicolas CAVALIE, Le Port Marly (FR)

(21) Appl. No.: 14/901,755

(22) PCT Filed: Jul. 2, 2014
(86) PCT No.: PCT/DE2014/000333

§ 371 Date: Dec. 29, 2015

(30) Foreign Application Priority Data
Jul. 2, 2013 (DE) 10 2013 212 896.7

(51) Int. Cl. E05B 85/20

(52) U.S. Cl. CPC E05B 85/20

(57) ABSTRACT

The invention relates to a door lock or flap lock comprising a locking mechanism that has a rotary latch and a pawl for locking the rotary latch. Said type of lock is also described in DE 103 20 457 A1. The invention also relates to a method for producing a plurality of said locks. The invention also relates to a lock with a position securing system with low technical complexity. The aim of the invention is to provide a lock with a locking mechanism comprising a rotary latch and a pawl for locking the rotary latch. The lock comprises a position securing system for a locking or anti-theft device. A spring is used for securing the position. Said spring is embodied as a dual-acting clamping spring.

### BACKGROUND

The invention relates to a latch for a door or a flap comprising a locking mechanism that has a catch and a pawl for locking the catch. Such a latch is disclosed in DE 103 20 457 A1. The invention also relates to a method for producing a plurality of said latches.

The aforementioned latch serves for temporary locking of openings in motor vehicles or buildings with the aid of doors or flaps. In the closed state of such a latch, the catch extends around an, in particular, bow-shaped latch bolt, which in case of a motor vehicle is generally fixed to the car body. Where as a result of being pivoted with the aid of the latch bolt, the catch is moved from an open into a closed position, the catch is then locked by means of the pawl. A blocking face of the pawl then rests against a blocking face of the catch, preventing the catch from being turned back in the direction of the open position. When in the closed position, the latch bolt can no longer leave the locking mechanism.

To open the mechanism, the pawl must be moved out of its detent position. Once the pawl has been moved out of its detent position, the catch turns into the direction of its open position. In the opened position of the catch and thus in the opened position of the locking mechanism, the latch bolt can leave the latch. The door or flap can then be opened again.

After the pawl has moved out of its detent position, the catch can be turned in the direction of the open position by a sealing pressure of the respective door or flap or by a pretensioned spring. Such a rotation can also be caused by the latch bolt being pulled out of the locking mechanism.

In some latches, the catch has two different detent positions. In this case, the catch can then be first locked in a so-called pre-ratchet position and then in the so-called main ratchet position by continuing rotation in the closing direction. Although in the pre-ratchet position a latch bolt can no longer leave the locking mechanism, a respective door or flap is, however, not fully closed. Such a door or flap is only fully closed when the catch is turned up to the main ratchet position and is locked in this position.

The latch can contain a blocking lever able to block a pawl when the pawl locks the catch. In order to open such a locking mechanism, the blocking lever must first be moved out of its blocking position.

In order to facilitate particularly easy opening of a latch, the catch can introduce an opening moment into the pawl in the locked state. The opening moment can cause the pawl to be moved out of its detent position. In such a latch, unwanted moving of the blocking lever out of its detent position is prevented. If the blocking lever is moved out of its blocking position, the latch then opens automatically.

An actuating means is provided for opening the latch. Upon activating the actuating means the locking mechanism is opened. A handle of a door or of a flap can be part of the actuating means. This handle is generally connected to the actuating lever of the latch by means of rods or a Bowden cable. Upon actuating the handle, the rods or the Bowden cable pivot the actuating lever of the latch in such a way that the latch opens.

Latches of motor vehicles are regularly equipped with a central locking (see e.g. DE 4108561 A1) and/or an anti-theft device (see e.g. DE 10 2011 018 512 A1). To lock a side door latch and engage an anti-theft device, respective mechanisms are provided, generating a rotational or linear movement and thus locking or unlocking the latch or engaging or releasing the anti-theft device.

For safety reasons, any movement of the locking or anti-theft device should be prevented in the event of an accident, i.e. movement from a locked into an unlocked position or, in case of the anti-theft device, movement from an engaged into a released position.

In order to protect a locking means or anti-theft device against movement into another position during an accident or crash, an arrangement can be provided in which one leg of a spring has to me moved against the force of the spring in order to be able to move the position of a latch or antitheft device. The greater the force required for moving such a spring leg, the greater the required acceleration in the event of a crash in order to be able to change the position of an anti-theft device or of a locking mechanism. By using the correct spring force it can thus be achieved that accelerations of 30 g or up to 55 g cannot change the position of an anti-theft device or of a central locking. g stands for gravitational acceleration. The leg spring secures the position of a locking mechanism or the position of an anti-theft device in case of high accelerations, as experienced in the event of a crash.

The position of a locking mechanism or anti-theft device is regularly changed with the aid of a motor, when required. The existence of a position securing system requires a respective motor power to overcome the position securing system, i.e. to move the spring leg in the said example.

### SUMMARY

The above characteristics can be individually or in any combination be part of the latch of the invention.

The invention aims to provide a latch with a correctly functioning position securing system.

The task of the invention is solved by a latch with the characteristics of the first claim. Advantageous embodiments are described in the dependent claims. An advantageous production method incorporates the characteristics of the subsidiary claim.

In order to solve this task the invention provides a latch comprising a locking mechanism that has a catch and a pawl for locking the catch. The latch includes a position securing system for a locking mechanism or an anti-theft device. A spring provides the position securing system. The spring is a double-direction pincer spring.

A spring is a double-direction pincer spring, if two legs of a spring have to be moved at the same time in order to be able to move the position of a locking mechanism or anti-theft device. In contrast to a one-direction spring, the inventive latch can advantageously move the locking mechanism or the anti-theft device with little force.

This is naturally subject to the fact that the respective position securing system can withstand the same acceleration forces.

Preferably, a stop is provided for the leg spring of the pincer spring, limiting the movement of the leg spring. This contributes to the fact that a relatively weak spring, i.e. a spring with a small spring constant can be used whilst still attaining a position securing system withstanding high accelerations of, for instance up to 30 g or up to 55 g.

One embodiment contains a pin, such as a cylindrical pin of the locking mechanism or of the anti-theft device on which the pincer spring acts on both sides in order to secure their position. The pin must be moved in order to change the position of the locking mechanism or of the anti-theft device. This can be a relative movement. Such a movement is counteracted by two legs of the pincer springs, which then rest against the pin. Such a movement of the pin causes the two legs of the pincer spring to be moved against the tension of the spring. This embodiment provides a position securing system requiring little installation space and little technical effort.

A spring in the context of the invention can also consist of two parts. It is only important that the spring contains two legs that have to be simultaneously moved against the force of the spring in order to unlock or lock a latch or to be able to move the position of an anti-theft device. Preferably the spring does, however, consist of a single part as this can minimize the technical effort required for production.

Movement of a leg in the context of the invention also occurs if not the entire leg but only a section of a leg is moved. A deformation of the leg is therefore also a leg movement in the context of the invention.

In one embodiment, the pin is linearly moved or can be linearly moved for changing a position of a locking mechanism or of an anti-theft device. This embodiment provides a particularly reliable functioning of the position securing system. In this way, a compact position securing system can be provided.

This contributes advantageously to be able to use a weakly dimensioned spring with a small spring constant to nevertheless provide a position securing system also able to withstand high accelerations.

In one embodiment, bodes ends of each leg are fixed. This advantageously contributes to using a weakly dimensioned spring whilst still providing a position securing system, also able to withstand high accelerations.

One embodiment includes a motor able to change the position of the locking mechanism or the position of the antitheft device. In contrast to arrangements in which a spring acting on a single side is used, a motor with a comparatively low power can be used. Consequently, a comparatively small and light-weight motor can be used. As a result, the overall required space and weight as well as the technical effort are kept to a minimum.

In order to produce the latch with little technical effort an in each case identical spring produces a plurality of position securing systems, preferably also fixed in an identical manner, so that the spring tensions always remain the same. In order to secure a position against different accelerations, as required, pins or cylindrical pins having different diameters and/or different cross sections will be used. With the same spring force acting on the pins and different diameters and differently shaped cross sections, different force characteristics are achieved. The forces to be met by a position securing system can thus be set, as required, by the selection of the pin, whilst the mechanism remains the same.

In order to produce position securing systems with an identical spring force that can nevertheless withstand different acceleration forces, pins with differently shaped cross sections can be used. Examples for such cross sections are triangular shapes, flattened circles or oval shapes. It is also possible to install pins, not having a circular cross section and which are differently aligned to each other in order to produce a position securing systems able to withstand different forces. Where, for instance, a pin with an oval cross section surface is used, the cross section surface is installed in such a way that the long extension of the oval runs parallel to the long extension of the legs, providing a position securing system, able to withstand relatively low acceleration forces. Where however, with the pin having the same design, the longitudinal extension of the oval is arranged transversely to the longitudinal extension of the legs of the spring, a position securing system is created that is able to withstand relatively large acceleration forces. Installing a pin not having a symmetrical circular cross section with a different alignment, as described, in order to be able to meet different acceleration forces, is equal to using pins with different diameters.

Below, the position securing system of a motor vehicle latch is explained in more detail with reference to one example, in which:

### BRIEF DESCRIPTION OF THE DRAWINGS

FIG. 1: shows two position securing systems;

FIG. 2: shows examples for a position securing system.

### DETAILED DESCRIPTION OF THE DRAWINGS

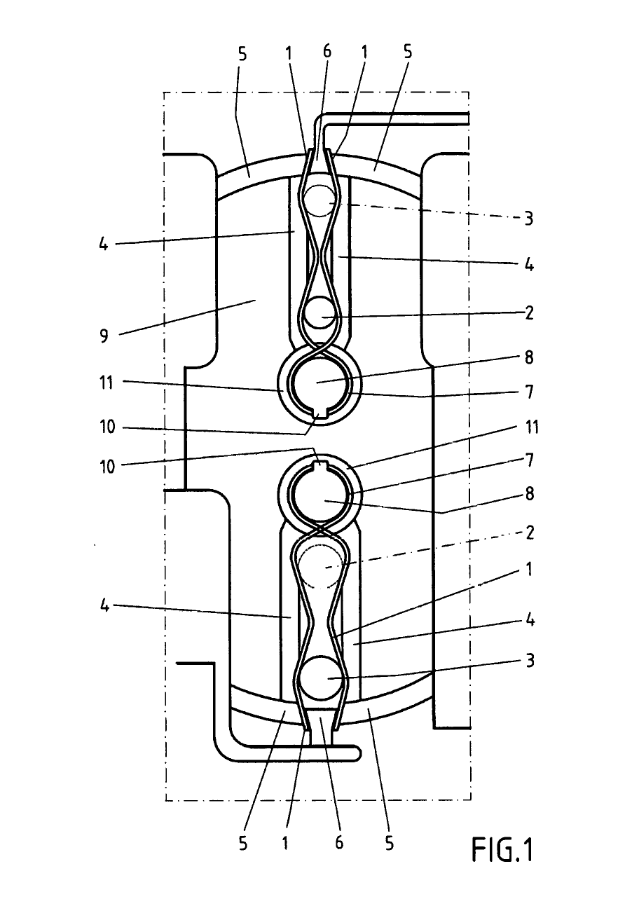

FIG. 1 shows two pincer springs acting on both sides each with two wave-shaped spring legs 1. The wave shape of legs 1 creates two positions for one pin. The legs 1 of each spring clasp or surround a pin, for instance a cylindrical pin in its respective resting position 2 or 3. The pin can be linearly displaced to and fro between a point or position 2 and a point or position 3. In order to move from point 2 to a point 3 or vice versa, the legs 1 of a pincer spring, which in this case forms a single part, are pushed apart in a centre area between the two positions 2 and 3 and against the tension of the spring. A resting position 2, 3 of each pin is thus secured by the two legs 1 of a spring.

The movement of the legs 1 is externally limited by the walls 4 serving as a stop. They limit the movement of the legs 1, caused by the change of position of a pin from 2 to 3 or vice versa. In this way it is ensured that a pin is secured against a displacement when exposed to considerable acceleration without having to use excessively large dimensioned springs, i.e. springs with great spring constants. In each case, two walls 4 run parallel to each other and parallel to the longitudinal extension of the respective spring with the legs 1. Two walls 5 serve to fix or secure the free end of legs 1. A wall area 6 between the two legs 1 of a spring in the area of the free ends also serve to secure or fix the free ends of legs 1. In particular, the free ends of legs 1 are positively or non-positively held or fixed by walls 5 and 6.

The other end 7 of each single-part spring, opposing the free end of legs 1 extends circularly around a pin 8 of the housing 9. A web 10 laterally protruding from the pin 8 contributes to maintaining the end 7 of each spring in a positively fitting manner. The end 7 is also surrounded by a wall 11, also contributing to a positive retention of end 7 of each spring. The end 7 is thus also fixed.

Where a latch is unlocked by an actuating lever, a pin is, for instance, moved from position 2 to a position 3. The spring with legs 1 prevents such movement and an associated unlocking solely for the reason of a high acceleration, as can occur in the event of a crash.

FIG. 1 show a top position securing system and a bottom position securing system. The two position securing systems are mechanically identical with the exception of the pin. The pin of the top position securing system has a smaller diameter than the pin of the bottom position securing system. Due to the smaller diameter, the top position securing system can withstand lower acceleration forces than the bottom position securing system.

The pins shown in FIG. 1 have a circular diameter. The pins are cylindrical pins. Instead of a circular diameter, the diameter of a pin can, for instance, be triangular semi-circular or oval.

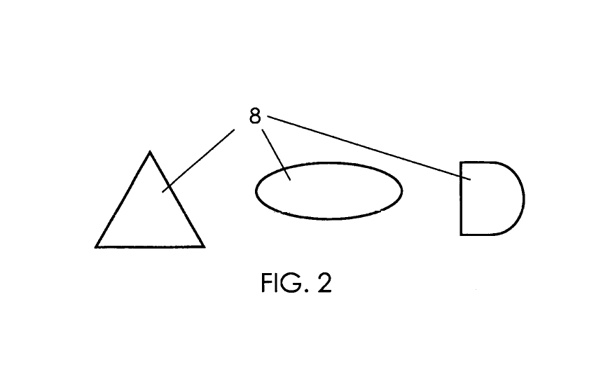

FIG. 2 shows different cross sections of pins 9 that can be alternatively used in a position securing means. The figure shows a triangular cross section, an oval cross section and a flattened circular shape. Depending on the shape, the dimension and installation direction, the desired acceleration forces can be set in a position securing system and which can be withstood by a position securing system.

### LIST OF REFERENCE NUMBERS

1: Leg of a pincer spring
2: Resting position of a pin
3: Resting position of a pin
4: Wall
5: Wall
6: Wall
7: End of spring
8: Housing pin
9: Pin cross sections for position securing system
10: Web
11: Wall

1. Latch comprising a locking mechanism that has a catch and a pawl for locking the catch and a position securing system containing a spring for a locking mechanism or an anti-theft device, characterized in that the spring is a pincer spring acting on both sides.

2. Latch according to claim 1, characterized in that a stop is provided for a leg spring of the pincer spring.

3. Latch according to claim 2, characterized by a pin, for instance a cylindrical pin, on which the pincer spring acts on both sides as the position securing system.

4. Latch according to claim 3, characterized in that the pin has to be linearly moved for changing a position of a locking mechanism or of the anti-theft device.

5. Latch according to claim 4, characterized in that one or two ends of each leg are fixed.

6. Latch according to claim 5, characterized in that a motor is provided with the aid of which the position of the locking mechanism or of the anti-theft device can be changed.

7. Latch according to claim 6, characterized in that the position securing system can secure a position when exposed to acceleration forces of up to 55 g.

8. System containing at least two latches according to claim 1, characterized in that the used springs are identical for one position securing system and for one latch and that a pin of a position securing system differs from a pin from another position securing system by its diameter and/or its cross section and/or its installation direction if the diameter is not circular.

9. Method for producing a plurality of latches with a position securing system according to claim 1, characterized in that all latches with springs are produced with identically effective spring forces of a position securing system but not with identical pins for each position securing system.

10. Latch according to claim 1, characterized by a pin, for instance a cylindrical pin, on which the pincer spring acts on both sides as the position securing system.

11. Latch according to claim 1, characterized in that a motor is provided with the aid of which the position of the locking mechanism or of the anti-theft device can be changed.

12. Latch according to, characterized in that the position securing system can secure a position when exposed to acceleration forces of up to 30 g.

13. Latch according to claim 1, characterized in that the position securing system can secure a position when exposed to acceleration forces of up to 55 g.
